(19) United States
(12) Patent Application Publication
(10) Pub. No.: US 2003/0208775 A1
(43) Pub. Date: Nov. 6, 2003

(54) System, method and apparatus for coordination of channel quality assessment and ingress filtering in cable modem systems

(76) Inventors: Harold A. Roberts, Prior Lake, MN (US); J. David Unger, Windham, NH (US)

Correspondence Address: LEFFERT JAY & POLGLAZE, P.A., P.O. BOX 581009, MINNEAPOLIS, MN, 55458-1009, US

(21) Appl. No.: 10/138,709

(22) Filed: May 3, 2002

(51) Int. Cl. H04N 7/173

(52) U.S. Cl. 725/125; 725/111

(57) ABSTRACT

A system, method and apparatus for coordinating the operation of channel quality assessment and analysis and ingress filtering of an active channel in a cable modem system.

### TECHNICAL FIELD

The present invention is related in general to cable modem systems and devices and more particularly to a system, method and apparatus for coordination of channel quality assessment and ingress filtering in cable modem systems.

### BACKGROUND INFORMATION

Upstream traffic in a cable modem system is characterized by many cable modems transmitting to a cable modem termination system (CMTS), typically on a single shared channel. Interference or ingress is frequently encountered in upstream traffic from cable modems and can be a difficult problem to solve.

Interference comes from a wide variety of sources and is constantly changing. Cable modem systems must be able to adapt to such changing channel conditions. There are several solutions to the problem of interference: (1) change modulation and coding schemes; (2) perform a channel quality assessment to measure the noise power in a channel and rank the channels accordingly allowing movement to channels with adequate quality; and (3) provide ingress noise filtering or equalization to improve the quality of the reception and/or transmission in a channel.

Although modulation schemes can be selected for robustness in the presence of noise, this reduces the data rate. Instead, systems are migrating toward modulation and coding schemes that transmit wider information bandwidth but require higher signal to noise ratios. An optimal cable modem system would both improve channel quality so that faster modulation schemes can be employed as well as be capable of assessing channel quality. Unfortunately, the coordination of channel quality assessment and ingress noise filtering is problematic. The present invention helps to prevent such problems from occurring.

There are two types of channel frequency hopping mechanisms used, blind hopping and ‘look ahead’ hopping. Blind hopping typically involves evaluation of the currently used channel quality and the hopping decision is based on this. The frequency that the channel hops to is predetermined with no regard to current channel quality. With look ahead hopping the decision to change channels typically involves performing a channel quality assessment of the currently used channel and one or more unused channels to evaluate the spectrum in anticipation of performing a channel hop.

### BRIEF DESCRIPTION OF THE DRAWINGS

FIG. 1 illustrates typical ingress found in a channel in the spectrum used for upstream transmissions in a cable modem system.

### DETAILED DESCRIPTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural and/or design changes may be made without departing from the scope of the present invention.

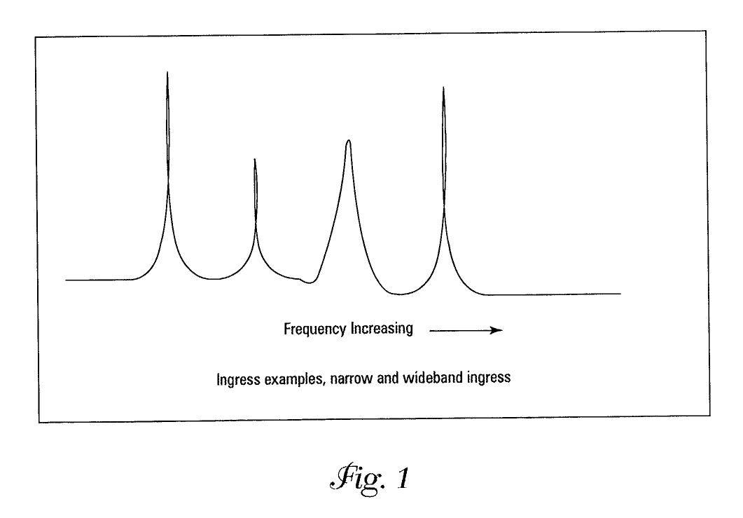

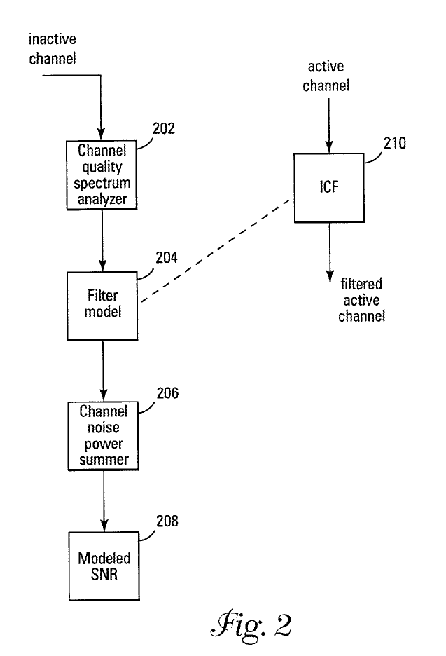

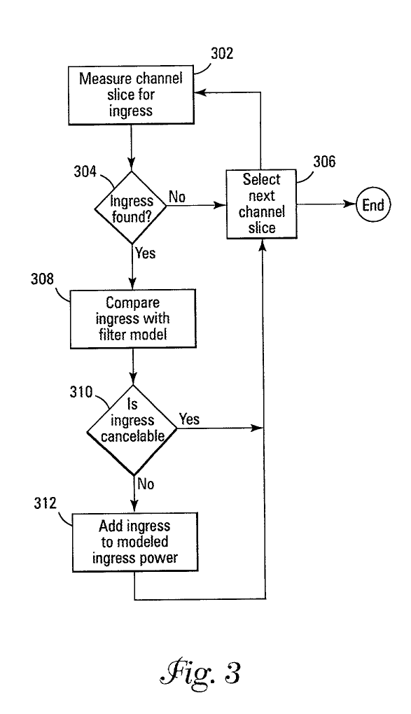

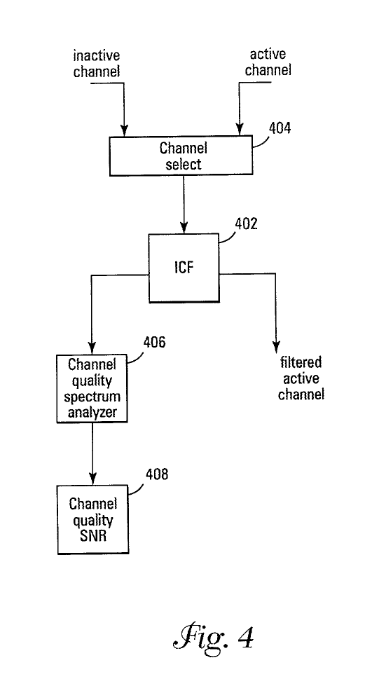

FIG. 1 illustrates ingress in a channel in the spectrum used for upstream transmissions in a cable modem system. The ingress is characterized by a number of relatively narrowband signals 102 of higher amplitude and wideband ingress 104 that is usually lower in amplitude.

Conventional channel quality assessment in a cable modem system uses a device similar to a spectrum analyzer at the CMTS to measure the total ingress power (i.e., the noise floor summed with narrow band and wide band ingress) in a channel and calculates the ratio of anticipated signal power to the measured ingress plus noise (s/n ratio or SNR). After the various channels have been evaluated in this way, and a s/n ratio may be obtained for each channel these will be compared to a table of predetermined channels and modulation profiles, sometimes referred to as a policy, when a decision to use a channel is made. The policies provide a range of channels, modulation and coding schemes, and required s/n ratios, in bandwidths varying from 3.2 MHz, 1.6 MHz, 0.8 MHz, down to 200 kHz. The policies represent a descending hierarchy of profiles based on required SNR or impulse noise tolerance to be used based on observed channel conditions.

The evaluation and policy selection process works, in general, as follows. The channel quality spectrum analyzer device provides a channel quality assessment for a channel associated with the second choice policy (the first choice policy is already being used) by calculating the ratio of anticipated signal power to the measured ingress signal power to obtain a signal to noise ratio. If the spectrum analyzer device determines that the channel quality is unacceptable for the second choice policy of the table, the spectrum analyzer will measure the s/n ratio for the channel associated with the third choice policy (if it is different from the channel used in the first policy) and determine whether that channel meets the s/n requirements of the third policy in the table. If the measured signal to noise ratio is lower than the ratio called for by the policy, it will skip to the fourth policy, perform another s/n measurement, check the next policy, and so forth, until a suitable policy is found for the measured signal to noise ratio.

Ingress cancellation or ingress cancellation filtering (ICF) operates in a different way. Since many noise sources are relatively narrow in bandwidth, it is frequently possible to filter such relatively narrowband ingress from the bandwidth occupied by the channel and obtain a useable channel with a greatly improved s/n ratio with no change in channel modulation or bandwidth.

An ICF works, in general, as follows. In one example, the ICF chip includes a spectrum analyzer that takes a snapshot of the active channel during a quiet time when no modems are transmitting to determine the frequencies at which there is ingress that is sufficiently narrow in bandwidth to be cancelable, typically 5 to 20 kHz. Because the ingress is constantly changing, the snapshot is taken frequently so that the ICF can be updated to dynamically adapt to changing channel conditions. One or more notch filters are then applied to filter the spectra occupied by the narrowband ingress. If enough of the channel ingress is capable of being cancelled or attenuated by the ICF, the channel can be used for modulation and coding schemes that would otherwise be unacceptable based on a conventional channel quality analysis which simply calculates the overall power of the ingress in the channel versus anticipated signal power. Unfortunately, ICF filtering is performed on the active channel after the channel quality assessment has selected the policy in the manner described above. As noted, conventional channel quality assessment is performed without taking into account the ability of the ICF to remove much of the ingress that is used to determine the s/n ratio.

Conventional channel quality assessment eliminates many channels that could be greatly improved by ICF and used effectively. Thus, coordination must take place between the two processes to ensure that the best channel is indeed always selected for the active channel. Coordination can be accomplished as follows. In one example, shown in FIG. 2, the performance of ICF 210 can be measured and characterized in a filter model 204. Note that this model may be predetermined through measurements, it need not be determined in real time. The term “filter model” as used herein includes predetermined filter models and copies as well as real time filter models and filter copies. The filter model 204 specifies that the ICF 210 is able to cancel or notch filter a predetermined number of ingress signals, that are 5 kHz wide, 10 kHz wide, and so forth and with various amplitudes relative to the signal. The actual ingress of the channel can then be measured by the channel quality assessment spectrum analyzer 202.

Operation of an embodiment of the present invention is shown in FIG. 3. Spectrum analyzer 202 measures the ingress present in very thin slices of bandwidth at 302 (in 5 kHz slices, for example). If ingress is found in the bandwidth slice at 304, the ingress is compared at 308 with the filter model 204 to determine if the observed ingress could be cancelled by the ICF. Any narrow or medium bandwidth noise that can be cancelled according to filter model 204 will not be included in the noise power sum 206 for that channel and the next channel slice if any will be selected at 306. The ingress power that cannot be filtered according to the model will be summed over the bandwidth of the channel at 312 and compared to the anticipated signal power to arrive at a modeled signal to noise ratio of the channel 208 for channel quality assessment. The channel would then be evaluated to determine which, if any, policies might be appropriate.

In another example, shown in FIG. 4, the actual ICF 402 can be ‘borrowed’ briefly, from its task of canceling ingress in the active channel, to perform a channel quality analysis of an inactive channel when there is an idle time and the ICF is not being actively used. Alternatively, idle times may be scheduled in the active channel by the CMTS for this purpose. The ICF 402 would then be switched via channel select 404 to look at another channel that is not active to take short measurements to determine at channel quality spectrum analyzer 406 what the channel quality SNR 408 may be. Of course, the time spent offline by ICF 402 would have to be kept to a minimum so as to avoid pent up demand for bandwidth. A number of such brief measurements may be obtained in this way and averaged to arrive at a better measurement of the channel quality.

Conclusion

A system, method and apparatus for coordination of channel quality assessment and ingress filtering in cable modem systems has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. A method for coordinating channel quality assessment and ingress cancellation filtering in a cable modem system, comprising:
modeling the performance of an ingress cancellation filter;
measuring the ingress of a channel;
comparing the measured ingress with the modeled performance of the ingress cancellation filter to determine if all or part of the ingress of the channel is capable of being canceled;
summing the power of ingress not cancelable according to the model to arrive at a modeled ingress power for the channel; and
performing a channel quality assessment based on the modeled ingress power.

2. The method of claim 1 wherein modeling the performance of the ingress cancellation filter comprises specifying that the ingress cancellation filter is able to cancel a plurality of ingress signals narrower than a predetermined bandwidth.

3. The method of claim 1 wherein measuring the ingress of a channel is performed by a spectrum analyzer.

4. The method of claim 3 wherein the spectrum analyzer measures the ingress of a channel in a series of narrow slices of bandwidth.

5. A system for coordinating a channel quality assessment and an ingress cancellation filter in a cable modem system, comprising:
a spectrum analyzer for performing a channel quality assessment;
an ingress cancellation filter;
an ingress cancellation filter model;
wherein ingress of a channel is measured by the spectrum analyzer and compared with the ingress cancellation filter model to determine if ingress measured by the spectrum analyzer can be cancelled by the ingress cancellation filter.

6. The system of claim 5 wherein the model specifies that the ingress cancellation filter is able to cancel a predetermined number of ingress signals each of which is narrower than a predetermined bandwidth.

7. The system of claim 5 wherein the ingress of the channel is measured by the spectrum analyzer in a series of narrow slices of bandwidth, and the measurements are compared with the ingress cancellation filter model to determine if one or more signals comprising the ingress measured by the spectrum analyzer are cancelable by the ingress cancellation filter.

8. A cable modem termination system, comprising:
a spectrum analyzer for measuring ingress of a channel;
an ingress cancellation filter; and
an ingress cancellation filter model;
wherein the ingress of a channel measured by the spectrum analyzer is modified by the ingress cancellation filter model to arrive at a modeled noise power for the channel.

9. The cable modem termination system of claim 8 wherein the modeled noise power is used in making a channel quality assessment.

10. The cable modem termination system of claim 8 wherein the spectrum analyzer measures the ingress of a channel that is not active and the ingress cancellation filter operates on an active channel.

11. A method for performing a channel quality assessment in a cable modem system that includes ingress cancellation filtering of an active channel, comprising:
measuring the ingress of a channel that is not active;
using the ingress cancellation filter in the channel quality assessment during a period when the active channel is not busy to filter the measured ingress of the channel that is not active;
summing the power of the filtered ingress to arrive at a filtered ingress noise power for the channel that is not active; and
performing a channel quality assessment based on the filtered ingress noise power.

12. The method of claim 11 wherein a plurality of the ingress noise power sums are averaged before performing the channel quality assessment.

13. A machine useable medium having machine readable instructions thereon for coordinating channel quality assessment and ingress cancellation filtering in a cable modem system, comprising instructions for:
modeling the performance of an ingress cancellation filter;
measuring the ingress of a channel;
comparing the measured ingress with the modeled performance of the ingress cancellation filter to determine if the ingress of the channel is capable of being canceled;
summing the power of the ingress not capable of being cancelled to arrive at a modeled ingress noise power for the channel; and
performing a channel quality assessment based on the modeled ingress noise power.

14. An apparatus for use in a cable modem system, comprising:
a spectrum analyzer for measuring the ingress of a channel;
an ingress cancellation filter; and
an ingress cancellation filter model;
wherein the ingress of a channel measured by the spectrum analyzer is modified by the performance of the ingress cancellation filter model to arrive at a modeled noise power for the channel.

15. The apparatus of claim 14 wherein the modeled noise power is used in making a channel quality assessment.

16. The apparatus of claim 14 wherein the spectrum analyzer measures the ingress of a channel that is not active and the ingress cancellation filter operates on an active channel.

17. A system for coordinating a channel quality assessment and an ingress cancellation filter in a cable modem system, comprising:
a spectrum analyzer for measuring ingress of a channel;
an ingress cancellation filter;
wherein the ingress measured by the spectrum analyzer is filtered by the ingress cancellation filter in performing a channel quality assessment.

18. The system of claim 17 wherein the ingress cancellation filter comprises a model of an ingress cancellation filter that operates on an active channel.

19. The system of claim 17 wherein the ingress cancellation filter operates on an active channel and is switched during periods of inactivity of the active channel to the spectrum analyzer channel.

20. The system of claim 17 wherein the ingress of the channel is measured by the spectrum analyzer in a series of narrow slices of bandwidth, and the measurements are filtered by the ingress cancellation filter to determine if one or more signals comprising the ingress measured by the spectrum analyzer are cancelable by the ingress cancellation filter.

21. A machine useable medium having machine readable instructions thereon for coordinating channel quality assessment and ingress cancellation filtering in a cable modem system, comprising instructions for:
switching an ingress cancellation filter from an active channel to an inactive channel during periods of inactivity;
measuring the ingress of the inactive channel;
filtering the measured ingress of the inactive channel by the ingress cancellation filter;
summing the power of the ingress not filtered to arrive at an ingress cancellation filtered noise power for the inactive channel; and
performing a channel quality assessment based on the ingress cancellation filtered noise power.

22. A cable modem termination system, comprising:
a spectrum analyzer for measuring ingress of an inactive channel; and
an ingress cancellation filter;
wherein the ingress of the channel measured by the spectrum analyzer is modified by the ingress cancellation filter to arrive at an ingress cancellation filtered noise power for the channel.

23. The cable modem termination system of claim 22 wherein the ingress cancellation filtered noise power is used in making a channel quality assessment.

24. The cable modem termination system of claim 22 wherein the spectrum analyzer measures the ingress of a channel that is inactive and the ingress cancellation filter operates on an active channel and is borrowed during periods of inactivity of the active channel for filtering of the inactive channel.
